(19) United States
(12) Patent Application Publication
(10) Pub. No.: US 2015/0081729 A1
(43) Pub. Date: Mar. 19, 2015

(54) METHODS AND SYSTEMS FOR COMBINING VEHICLE DATA

(71) Applicant: GM GLOBAL TECHNOLOGY OPERATIONS LLC, Detroit, MI (US)

(72) Inventors: DNYANESH RAJPATHAK, BANGALORE (IN); PRAKASH MOHAN M. PERANANDAM, BANGALORE (IN); SOUMEN DE, BANGALORE (IN); JOHN A. CAFEO, FARMINGTON, MI (US); JOSEPH A. DONNDELINGER, DEARBORN, MI (US); PULAK BANDYOPADHYAY, ROCHESTER HILLS, MI (US)

(73) Assignee: GM GLOBAL TECHNOLOGY OPERATIONS LLC, Detroit, MI (US)

(21) Appl. No.: 14/032,022

(22) Filed: Sep. 19, 2013

(51) Int. Cl. G06F 17/30

(52) U.S. Cl. CPC G06F 17/30595
USPC 707/758

(57) ABSTRACT

Methods and systems are provided for automatically comparing, combining and fusing vehicle data. First data is obtained pertaining to a first plurality of vehicles. Second data is obtained pertaining to a second plurality of vehicles. The first data and the second data are compared and combined based on syntactic similarity between respective data elements of the first data and the second data collected during different stages of vehicle life cycle development.

### TECHNICAL FIELD

The technical field generally relates to the field of vehicles and, more specifically, to natural language processing and statistical techniques based methods for combining and comparing system data.

### BACKGROUND

Today data is generated for vehicles from various sources at various times in the life cycle of the vehicle. For example, data may be generated whenever a vehicle is taken to a service station for maintenance and repair, it is also generated during early stages of vehicle design and development via design failure mode and effects analysis (DFMEA). Because data is collected during different stages of vehicle development, analogous types of vehicle data may not always be recorded in a consistent manner. For example, in the case of certain vehicles having an issue with a window in the DFMEA data the related failure modes may be recorded as ‘window not operating correctly’ whereas when a vehicle goes for servicing and repair one technician may record the issue as “window not operating correctly”, while another may use “window stuck”, yet another may use “window switch broken”, and so on. Accordingly, it may be difficult to effectively combine such different vehicle data to find the new failure modes, effects and causes, for example that are observed in the warranty data which can be in-time augmented in the DFMEA data for further improving products and services of future releases.

Accordingly, it may be desirable to provide improved methods, program products, and systems for combining and comparing vehicle data, for example from different sources and identify the new failure modes or effects or causes observed at the time of failure for their augmentation in the data generated in the early stages of vehicle design and development, e.g. DFMEA. Furthermore, other desirable features and characteristics of the present disclosure will become apparent from the subsequent detailed description of the disclosure and the appended claims, taken in conjunction with the accompanying drawings and this background of the disclosure.

### SUMMARY

In accordance with an exemplary embodiment, a method is provided. The method comprises the steps of obtaining first data comprising data elements pertaining to a first plurality of vehicles (e.g., the data points collected during the early stages of vehicle design and development, such as DFMEA), obtaining second data comprising data elements pertaining to a second plurality of vehicles (e.g., the data collected during the warranty period that takes the form of unstructured repair verbatim), and automatically comparing and combining the first data and the second data, via a processor, based on syntactic similarity between respective data elements of the first data and the second data.

In accordance with an exemplary embodiment, a program product is provided. The program product comprises a program and a non-transitory, computer readable storage medium. The program is configured to at least facilitate obtaining first data comprising data elements pertaining to a first plurality of vehicles, obtaining second data comprising data elements pertaining to a second plurality of vehicles, and combining the first data and the second data, via a processor, based on syntactic similarity between respective data elements of the first data and the second data. The non-transitory, computer readable storage medium stores the program.

In accordance with a further exemplary embodiment, a system is provided. The system comprises a memory and a processor. The memory stores first data comprising data elements pertaining to a first plurality of vehicles and second data comprising data elements pertaining to a second plurality of vehicles. The processor is coupled to the memory, and is configured to combine the first data and the second data based on syntactic similarity between respective data elements of the first data and the second data.

### BRIEF DESCRIPTION OF THE DRAWINGS

Certain embodiments of the present disclosure will hereinafter be described in conjunction with the following drawing figures, wherein like numerals denote like elements, and wherein:

FIG. 1 is a functional block diagram of a system for automatically comparing and combining vehicle data collected during different stages of vehicle development process, and is depicted along with multiple data sources coupled to respective pluralities of vehicles, in accordance with an exemplary embodiment;

FIG. 2 is a flow diagram of a flow path for combining vehicle data, and that can be used in conjunction with the system of FIG. 1, in accordance with an exemplary embodiment;

FIG. 3 is a flowchart of a process for combining vehicle data corresponding to the flow diagram of FIG. 2, and that can be used in conjunction with the system of FIG. 1, in accordance with an exemplary embodiment;

FIG. 4 is a flowchart of a sub-process of the process of FIG. 3, namely, classifying elements from first data, in accordance with an exemplary embodiment;

FIG. 5 is a flowchart of another sub-process of the process of FIG. 2, namely, classifying elements from second data, in accordance with an exemplary embodiment; and

FIG. 6 is a flowchart of another sub-process of the process of FIG. 3, namely, determining syntactic similarity between the first and second data, in accordance with an exemplary embodiment.

### DETAILED DESCRIPTION

The following detailed description is merely exemplary in nature, and is not intended to limit the disclosure or the application and uses thereof. Furthermore, there is no intention to be bound by any expressed or implied theory presented in the preceding technical field, background, or the following detailed description.

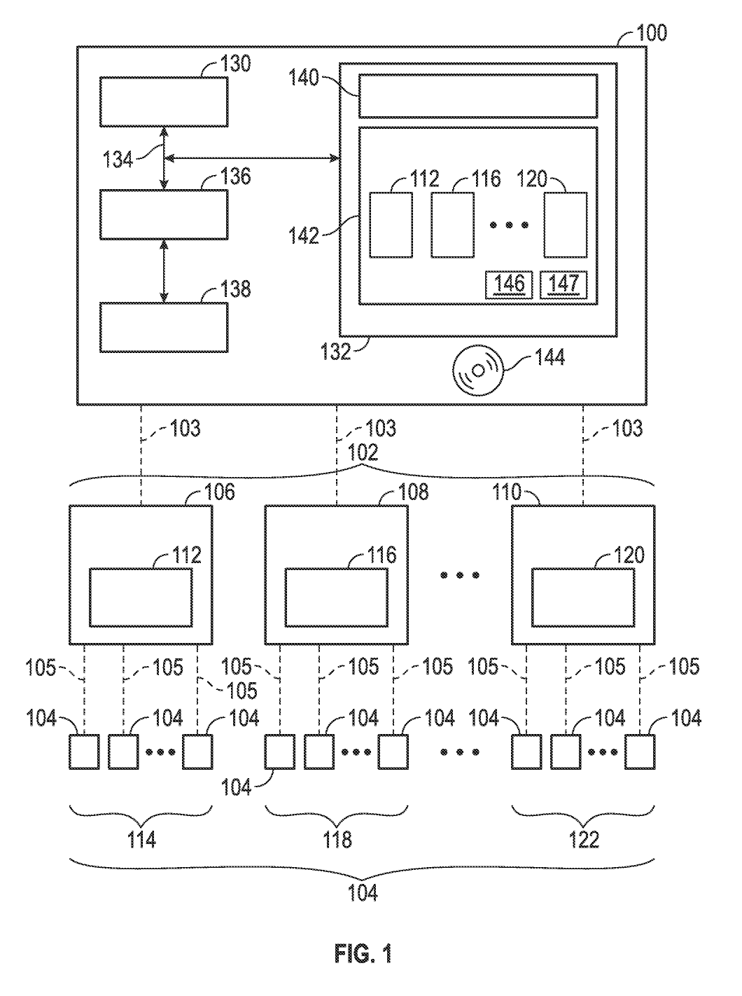

FIG. 1 is a functional block diagram of a system 100 for automatically comparing and combining vehicle data collected during different stages of vehicle development process, in accordance with an exemplary embodiment. The system 100 is depicted along with multiple sources 102 of vehicle data. The system 100 is coupled to the sources 102 via one or more communication links 103. In one embodiment, the system 100 is coupled to the sources 102 via one or more wireless networks 103, such as by way of example, a global communication network/Internet, a cellular connection, or one or more other types of wireless networks. Also in one embodiment, the sources 102 are each disposed in different geographic locations from one another and from the system 100, and the system 100 comprises a remote, or central, server location.

As depicted in FIG. 1, each of the sources 102 is coupled to a respective plurality of vehicles 104 via one or more wired or wireless connections 105, and generates vehicle data pertaining thereto. For example, a first source 106 generates first data 112 pertaining to a first plurality of vehicles 114 coupled thereto, a second source 108 generates second data 116 pertaining to a second plurality of vehicles 118 coupled thereto, an “nth” source 110 generates “nth” data 120 pertaining to an “nth” plurality of vehicles 122 coupled thereto, and so on. As noted by the “ . . . ” in FIG. 1, there may be any number of vehicle data sources 102, corresponding vehicle data, and/or pluralities of vehicles 104 in various embodiments.

Each source 102 may represent a different service station or other entity or location that generates vehicle data (for example, during vehicle maintenance or repair). The vehicle data may include any values or information pertaining to particular vehicles, including the mileage on the vehicle, maintenance records, any issues or problems that are occurring and/or that have been pointed out by the owner or driver of the vehicle, the causes of any such issues or problems, actions taken, performance and maintenance of various systems and parts, and so on.

At least one such source 102 preferably includes a source of manufacturer data for design failure mode and effects analysis (DFMEA). The DFMEA data is generated in the early stages of system design and development. It typically consists of different components in the system, the failure modes that can be expected in the system, the possible effect of the failure modes, and the cause of the failure mode. It also consists of PRN number associated with each failure mode, which indicates the severity of the failure mode if it is observed in the field. The DFMEA data is created by the experts in each domain and after they have seen the system analysis, which may include modeling, computer simulations, crash testing, and of course the field issues that have been observed in the past.

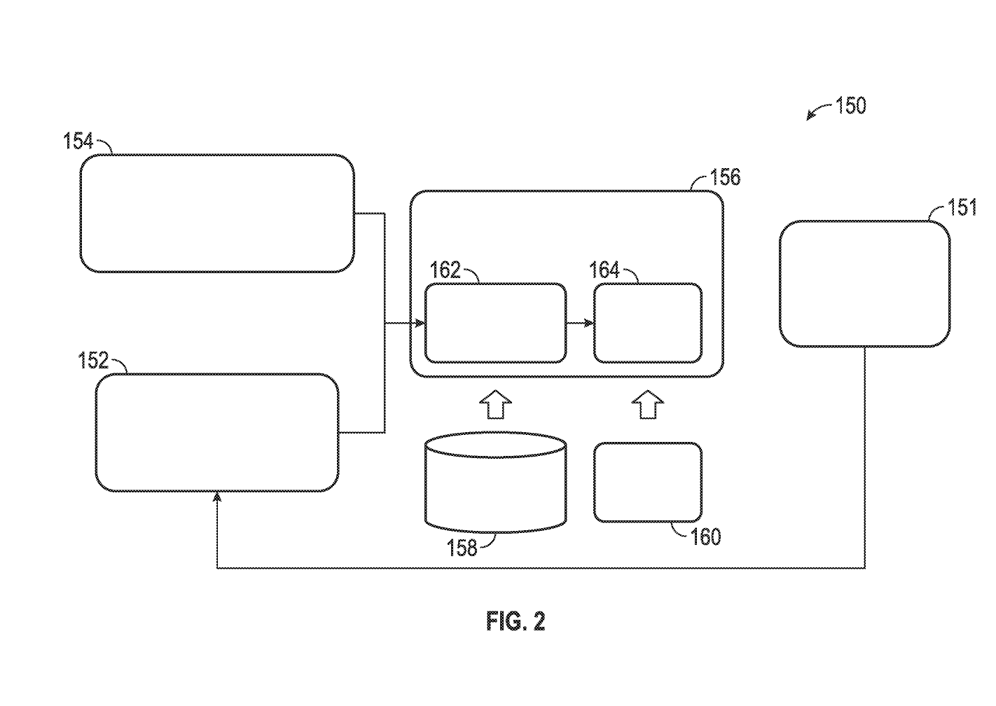

The vehicles for which the vehicle data pertain preferably comprise automobiles, such as sedans, trucks, vans, sport utility vehicles, and/or other types of automobiles. In certain embodiments the various pluralities of vehicles 102 (e.g. pluralities 114, 118, 122, and so on) may be entirely different, and/or may include some overlapping vehicles. In other embodiments, two or more of the various pluralities of vehicles 102 may be the same (for example, this may represent the entire fleet of vehicles of a manufacturer, in one embodiment). In either case, the vehicle data is provided by the various vehicle data sources 102 to the system 100 (e.g., a central server) for storage and processing, as described in greater detail below in connection with FIG. 1 as well as FIGS. 2-6.

As depicted in FIG. 1, the system 100 comprises a computer system (for example, on a central server that is disposed physically remote from one or more of the sources 102) that includes a processor 130, a memory 132, a computer bus 134, an interface 136, and a storage device 138. The processor 130 performs the computation and control functions of the system 100 or portions thereof, and may comprise any type of processor or multiple processors, single integrated circuits such as a microprocessor, or any suitable number of integrated circuit devices and/or circuit boards working in cooperation to accomplish the functions of a processing unit. During operation, the processor 130 executes one or more programs 140 preferably stored within the memory 132 and, as such, controls the general operation of the system 100.

The processor 130 receives and processes the above-referenced vehicle data from the from the vehicle data sources 102. The processor 130 initially compares data collected at different sources, combines and fuses the vehicle data based on syntactic similarity between various corresponding data elements of the different vehicle data, for example for use in improving products and services pertaining to the vehicles, such as future vehicle design and production. The processor 130 preferably performs these functions in accordance with the steps of process 200 described further below in connection with FIGS. 2-6. In addition, in one exemplary embodiment, the processor 130 performs these functions by executing one or more programs 140 stored in the memory 132.

The memory 132 stores the above-mentioned programs 140 and vehicle data for use by the processor 130. As denoted in FIG. 1, the term vehicle data 142 represents the vehicle data as stored in the memory 132 for use by the processor 130. The vehicle data 142 includes the various vehicle data from each of the vehicle data sources 102, for example the first data 112 from the first source 106, the second data 116 from the second source 108, the “nth” data 120 from the “nth” source 110, and so on. In addition, the memory 132 also preferably stores domain ontology 146 (preferably, critical concepts and the relations between these concepts frequently observed in data for various vehicle systems and sub-systems) and look-up tables 147 for use in determining syntactic similarity among terms in the data.

The memory 132 can be any type of suitable memory. This would include the various types of dynamic random access memory (DRAM) such as SDRAM, the various types of static RAM (SRAM), and the various types of non-volatile memory (PROM, EPROM, and flash). In certain embodiments, the memory 132 is located on and/or co-located on the same computer chip as the processor 130. It should be understood that the memory 132 may be a single type of memory component, or it may be composed of many different types of memory components. In addition, the memory 132 and the processor 130 may be distributed across several different computers that collectively comprise the system 100. For example, a portion of the memory 132 may reside on a computer within a particular apparatus or process, and another portion may reside on a remote computer off-board and away from the vehicle.

The computer bus 134 serves to transmit programs, data, status and other information or signals between the various components of the system 100. The computer bus 134 can be any suitable physical or logical means of connecting computer systems and components. This includes, but is not limited to, direct hard-wired connections, fiber optics, infrared and wireless bus technologies.

The interface 136 allows communication to the system 100, for example from a system operator or user, a remote, off-board database or processor, and/or another computer system, and can be implemented using any suitable method and apparatus. In certain embodiments, the interface 136 receives input from and provides output to a user of the system 100, for example an engineer or other employee of the vehicle manufacturer.

The storage device 138 can be any suitable type of storage apparatus, including direct access storage devices such as hard disk drives, flash systems, floppy disk drives and optical disk drives. In one exemplary embodiment, the storage device 138 is a program product including a non-transitory, computer readable storage medium from which memory 132 can receive a program 140 that executes the process 200 of FIGS. 2-6 and/or steps thereof as described in greater detail further below. Such a program product can be implemented as part of, inserted into, or otherwise coupled to the system 100. As shown in FIG. 1, in one such embodiment the storage device 138 can comprise a disk drive device that uses disks 144 to store data.

It will be appreciated that while this exemplary embodiment is described in the context of a fully functioning computer system, those skilled in the art will recognize that certain mechanisms of the present disclosure may be capable of being distributed using various computer-readable signal bearing media. Examples of computer-readable signal bearing media include: flash memory, floppy disks, hard drives, memory cards and optical disks (e.g., disk 144). It will similarly be appreciated that the system 100 may also otherwise differ from the embodiment depicted in FIG. 1, for example in that the system 100 may be coupled to or may otherwise utilize one or more remote, off-board computer systems.

FIG. 2 is a flow diagram of a flow path 150 for combining vehicle data, in accordance with an exemplary embodiment. In a preferred embodiment, the flow path 150 can be implemented by the system 100 of FIG. 1.

As shown in FIG. 2, the flow path 150 includes data to be augmented 151. The data to be augmented 151 comprises first vehicle data 152 from a first data source. In one embodiment, the first vehicle data 152 comprises DFMEA data, and corresponds to the first vehicle data 112 of FIG. 1. The first vehicle data 152 is provided, along with second vehicle data 154 from a second data source, to a syntactic data analysis module 156. In one embodiment, the second vehicle data 154 comprises vehicle field data, such as from a Global Analysis Reporting Tool (GART), a problem resolution tracking system (PRTS), a technical assistance center (TAC)/CAC system, or the like, and corresponds to the second vehicle data 115 of FIG. 1. By way of background, when a fault observed in correspondence with a specific system is difficult to diagnose (e.g., as it is seen for the first time in the field, or if the service information documents do not provide necessary support to perform the root-cause investigation), in such cases technicians contact TAC where the experts provide necessary step-by-step diagnostic information to technicians. The data associated with such instances is collected in the TAC database. By way of further background, customer assistance center (CAC) refers to when customers face any issues with a vehicle either in the form of the features they are happy about or cases in which specific features are not working, e.g. Bluetooth. In addition, domain ontology 158 (e.g., including critical concepts and the relations between these concepts frequently observed in vehicle data pertaining to a particular vehicle system or sub-system, such as power windows, and preferably corresponding to the domain ontology 146 of FIG. 1) and look-up tables 160 (preferably, corresponding to the look-up tables 147 of FIG. 1) are provided to the syntactic data analysis module 156.

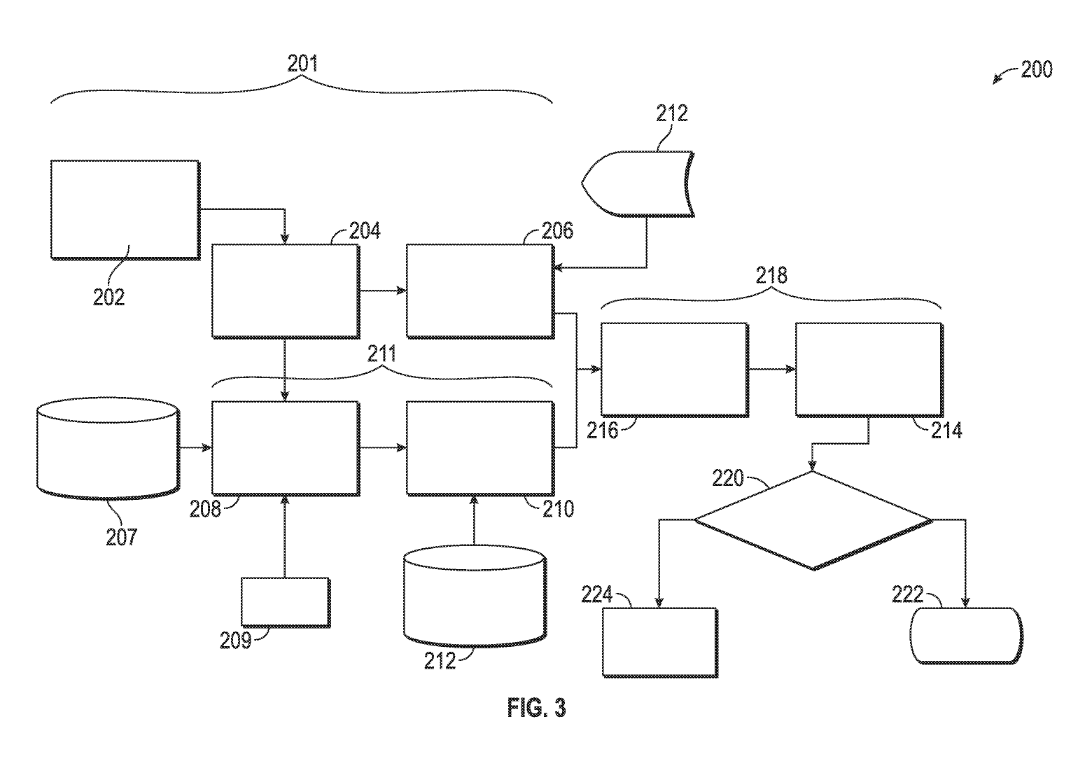

The syntactic data analysis module 156 uses the first vehicle data 152, the second vehicle data 154, the domain ontology 158, and the look-up tables 160 in collecting contextual information 162 from the first data 152 and the second data 154 and calculating a syntactic similarity 164 for elements of the first and second data 152, 154 using the contextual information 162. As explained further below in connection with FIG. 3, the syntactic similarity 164 preferably comprises a Jaccard Distance among terms. Accordingly, the syntactic data analysis module 156 is able to determine a measure of similarity between synonyms (e.g., “windows not working”, “windows will not go down”), and so on, which can then be used to augment the data to be augmented 151 (for example, by grouping synonymous terms together for analysis, and so on). The information provided via the syntactic similarity can be used to augment the data to be augmented 151, for example by grouping synonyms (i.e., terms with a high degree of syntactic similarity with one another) together for analysis, and so on.

As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality. Accordingly, in one embodiment, the syntactic data analysis module 156 comprises and/or is utilized in connection with all or a portion of the system 100, the processor 130, the memory 132, and/or the program 140 of FIG. 1. Also in one embodiment, the flow path 150 of FIG. 2 corresponds to a process 200 as depicted in FIGS. 3-7 and described below in connection therewith.

FIG. 3 is a flowchart of a process 200 for combining vehicle data, in accordance with an exemplary embodiment. In one embodiment, the process 200 comprises a methodology for in-time augmentation of DFMEA data by fusing natural language processing and statistical techniques. The process 200 corresponds to the flow path 150 of FIG. 2, and the flowchart of FIG. 3 preferably comprises a more detailed presentation of the same flow path 150 from the flow diagram of FIG. 2. In a preferred embodiment, the process 200 can be implemented by the system 100 of FIG. 1 (including the processor 130, memory 132, and program 140 thereof) and the syntactic data analysis module 156 of FIG. 2.

As depicted in FIG. 3, the process 200 includes the step of collecting first data (step 202). In one embodiment, the first data represents first data 112 from the first source 106 of FIG. 1. Also in one embodiment, the first data of step 202 comprises vehicle manufacturer via design failure mode and effects analysis (DFMEA) data. The first data is preferably obtained in step 202 by the system 100 of FIG. 1 via the first source 106 of FIG. 1, and is preferably stored in the memory 132 of the system 100 of FIG. 1 for use by the processor 130 thereof. In addition, the first data preferably corresponds to the first data 152 of FIG. 2.

Key terms are identified from the first data (step 204). The key terms preferably include references to vehicle systems, vehicle parts, failure modes, effects, and causes from the first data. The key terms are preferably identified by the processor 130 of FIG. 1.

The specific parts, failure modes, effects, and causes are then identified using the key terms, preferably by the processor 130 of FIG. 1 (step 206). The effects preferably include, for example, a particular issue or problem with a particular system or component of the vehicle (for example, front driver window is not operating correctly, and so on). The effects are preferably identified using domain ontology 212. The domain ontology is preferably stored in the memory 132 of FIG. 1 as part of the vehicle data 142. The domain ontology typically consists of critical concepts and the relations between these concepts frequently observed in the vehicle data. For example, some of the critical concepts can be System, Subsystem, Part, Failure Mode, Effects, Causes, and Repair Actions. The domain ontology also consists of instances of the critical concepts, for example, the concept Failure Mode can have instances such as Battery_Internally_Shorted, ECM_Inoperative and the like, and these instances are used by the algorithm to identify the key terms by the processor 130 of FIG. 1. The domain ontology preferably corresponds to the domain ontology 146 of FIG. 1 and the domain ontology 158 of FIG. 2. Steps 202-206 are also denoted in FIG. 3 as a combined sub-process 201.

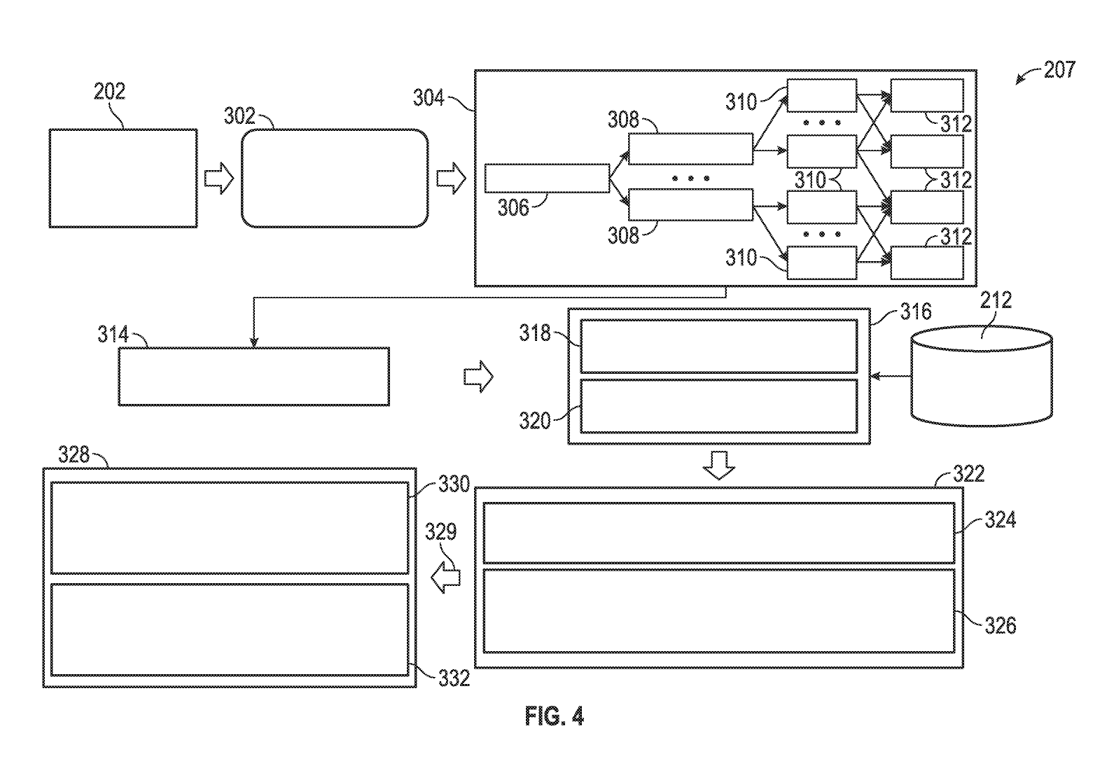

With reference to FIG. 4, a flowchart is provided for the sub-process 201 of FIG. 3, namely, classifying elements from the first data. As shown in FIG. 4, after the first data is obtained in step 202, various items, functions, failure modes, effects, and causes are extracted from the first data (step 302). This step is preferably performed by the processor 130 of FIG. 1.

Also as shown in FIG. 4, a hierarchy is generated (step 304). For each item or function 306 of the vehicle (for example, vehicle windows, vehicle engine, vehicle drive train, vehicle climate control, vehicle braking, vehicle entertainment, vehicle tires, and so on), various possible failure modes 308 are identified (e.g., window switch is not operating). For each failure mode 308, various possible effects 310 are identified (for example, window is not opening completely, window is stuck, and so on). For each effect 310, various causes 312 are identified (for example, window switch is stick, window pane is broken, and so on). Step 304 is preferably performed by the processor 130 of FIG. 1.

One of the effects is then selected for analysis (step 314), preferably by the processor 130 of FIG. 1. In one such example, an effect comprising “windows not working” is selected in a first iteration of step 314. In subsequent iterations, other effects would similarly be chosen for analysis.

For the particular chosen effect, various related identifications are made (step 316). The related identifications of step 316 are preferably made by the processor 130 of FIG. 1 using the above-mentioned domain ontology 212 from FIG. 3 for the particular effect selected in a current iteration of step 314. In the example discussed above with respect to “windows not working”, the domain ontology 212 pertaining to power windows may be used, and so on. Step 316 may be considered to comprise two related sub-steps, namely, steps 318 and 320, discussed below.

During step 318, vehicle parts are identified from the item or function associated with the selected effect in the current iteration. For example, in the case of the effect being “windows not working”, the identifications of step 318 may pertain to window switches, window panes, a power source for the window, and so, related to this effect. These identifications are preferably made by the processor 130 of FIG. 1.

During step 320, vehicle parts and symptoms are identified from failure modes, effects, and causes associated with the selected effect in the current iteration. For example, in the case of the effect being “windows not working”, the identifications of step 320 may pertain to causes, such as “power source failure”, “window switch deformation”, and so on. Corresponding effects may comprise “windows not working”, “less than optimal window performance”, and so on. Causes may include “unsuitable material”, “improper dimension”, and so on. These identifications are preferably made by the processor 130 of FIG. 1. Typically, the Item/Function string for example, “Individual Switch—Module Switch” and the effect string, for example “windows not working” consists of a part (i.e. Switch, Module Switch, Windows) and a symptom (not working) and it is necessary to identify these constructs by using the instances from the domain ontology. Having identified these constructs, they are used to select the relevant data points from the second vehicle data, such as warranty repair verbatim (language) that may include such constructs. For example, such warranty repair verbatim may be selected as the relevant data points from the second vehicle data (such as the field vehicle data) which can be used to compare, combine and fuse with the second data (e.g., the DFMEA data) to identify new failure mode, effects, and so on.

Strings are generated for the identified data elements (step 322). The strings are preferably generated by the processor 130 of FIG. 1. The strings are preferably generated using two rules, as set forth below.

In accordance with a first rule (rule 324), the string includes a part name (Pᵢ) for a vehicle part along with a symptom number (Sᵢ) for a symptom (or effect) corresponding to the vehicle part. In the above-described example, the part name (Pᵢ) may pertain, for example, to a manufacturer or industry name for a power window system (or a power window switch), while the symptom name (Sᵢ) may pertain to a manufacturer or industry name for a symptom (e.g., “not working” for the power window switch, and so on). One example of such a string in accordance with Rule 324 comprises the string “XXX XX Pᵢ XX XXX Sᵢ”, in which Pᵢ represents the part number, Sᵢ represents the symptom number, and the various “X” entries include related data (such as failure modes, effects, and causes).

In accordance with a second rule (rule 326), a determination is made to ensure that the string is not a sub-string of any longer string. For example, in the illustrative string “XSᵢ XSⱼX PᵢXX XPⱼX”, the term Pᵢ is considered to be valid but not the term Pⱼ, or the term Sᵢ would be considered to be valid but not the term Sⱼ, in order to avoid redundancy.

First data output 328 is generated using the strings (step 329). The output preferably includes a first component 330 and a second component 332. The first component 330 pertains to a particular part that is identified as being associated with identified items or functions and from effects and causes for the vehicle. The first component 330 of the output may be characterized in the form of {P₁, . . . , Pᵢ}, representing various vehicle parts (for example, pertaining to the windows, in the exampled referenced above). The second component 332 pertains to a particular symptom pertaining to the identified part. The second component 332 of the output may be characterized in the form of {S₁, . . . , Sᵢ}, representing various symptoms (for example, “not working”) associated with the vehicle parts. The output is preferably generated by the processor 130 of FIG. 1. Steps 314-329 are preferably repeated for the various parts and symptoms from the first data.

Returning to FIG. 3, second data is collected (step 208). The second data preferably includes data with elements that are related to corresponding elements of the first data analyzed with respect to steps 202-206 (including the sub-process of FIG. 4), as discussed above. In one example, the second data is obtained with similar vehicle parts and symptoms as those identified in the above-described steps for the first data. In addition, the second data preferably corresponds to the second data 154 of FIG. 2.

In one embodiment, the second data represents second data 116 from the second source 108 of FIG. 1. Also in one embodiment, the second data of step 208 comprises vehicle data and the field data, for example as obtained during the early stages of vehicle design and development and vehicle maintenance and repair at various service stations at various times throughout the useful life cycle of the vehicle. In this embodiment, the system enables systematic comparison between the structured data collected during early stages of vehicle design and development, e.g. DFMEA with unstructured free flowing data that is collected in the form repair verbatim from different dealers. As discussed earlier, one of the contributions of this invention is it provides a systematic basis to compare, combine and fuse structured data with unstructured data via syntactic analysis. The second data is preferably obtained in step 208 by the system 100 of FIG. 1 by the second source 108 of FIG. 1, and is preferably stored in the memory 132 of the system 100 of FIG. 1 for use by the processor 130 thereof. As denoted in FIG. 3, in certain embodiments, the second data of step 208 may be obtained using a Global Analysis Reporting Tool (GART) 207 and/or a problem resolution tracking system (PRTS) 209, which may be generated in conjunction with the various vehicle data sources 102 of FIG. 1. It will be appreciated that various additional data (for example, corresponding to the “nth” data 120 from one or more “nth” additional sources 110 of FIG. 1) may similarly be obtained (e.g. from multiple service stations and/or at multiples throughout the vehicle life cycle) and used in the same manner set forth in FIG. 3 in various iterations of the process 200.

Also as depicted in FIG. 3, the second data is classified, and symptoms are collected from the second data (step 210). As used in the context of this Application, the terms “symptom” and “effect” are intended to be synonymous with one another. The symptoms preferably include, for example, a particular issue or problem with a particular system or component of the vehicle (for example, “front driver window is not operating correctly”, and so on). The symptoms are preferably identified using the above-referenced domain ontology 212. Steps 208 and 210 are also denoted in FIG. 3 as a combined sub-process 211, discussed below.

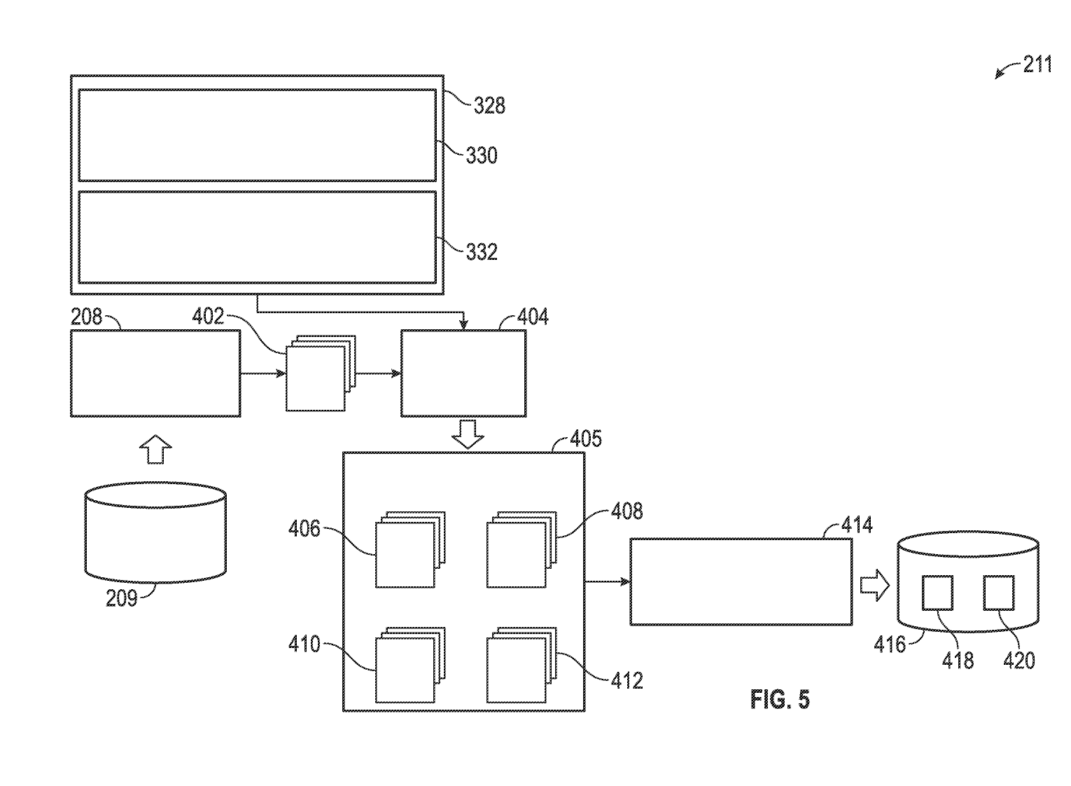

With reference to FIG. 5, a flowchart is provided for the sub-process 211 of FIG. 3, namely, classifying elements from the second data. As shown in FIG. 5, after the second data is obtained with elements pertaining to corresponding to the first data in step 208 (e.g., pertaining to the same or a similar vehicle part), technical codes are extracted from the second data to generate “verbatim data” (step 402). The verbatim data comprises the same data results as the second data in its raw form, except that notations from various entries use manufacturer or industry codes pertaining to the type of vehicle (e.g., year, make, and mode), along with the vehicle parts, symptoms, failure modes, and the like. In one embodiment, during step 402, special characters are replaced with known manufacturer or industry codes. If a string with a particular code includes a particular part identifier (Pᵢ) and is not a member of another string, then the code is collected in a category denoting that the string includes a part from the first data. Conversely, if a string with a particular code includes a particular symptom identifier (Sᵢ) and is not a member of another string, then the code is collected in a category denoting that the string includes a symptom from the first data. The term “verbatim data” can be illustrated via the following non-limiting example. When vehicle visits a dealer in case fault induced situation a technician collects the symptoms and also observe the diagnostic trouble code that are set in a vehicle. Based on this information the failure modes are identified which provide necessary engineering specific information about how a specific fault has occurred and the based on this information an appropriate corrective actions is taken to fix the problem. All of this information collected during fault diagnosis and root-cause investigation process is book kept in the form of the repair verbatim, which is typically in the form of free flowing Engligh language. One such example of the repair verbatim is as follows—“Customer stage battery is leaking and cable is corroded found negative terminal on battery leaking causing heavy corrosion on cable an dreplaced battery, ngative cable, and R-R battery to cle”. This step is preferably performed by the processor 130 of FIG. 1.

The second data is then classified (step 404). Specifically, the second data is classified using the technical codes and the verbatim data of step 402 along with the output 328 from the analysis of the first data, (e.g., using the parts and symptoms identified in the first data to filter the second data). All such data points are preferably collected, and preferably include records of parts and symptoms from the first data, including the first component 330 and the second component 332 of the output 328 as referenced in FIG. 4 and discussed above in connection therewith. Accordingly, during step 404, the second data is classified by associating the specific codes for data elements for the verbatim data of the second data (from step 402) with potentially analogous data elements from the first data, such as pertaining to a particular vehicle part (e.g., with respect to the first data output 328). The classification is preferably performed by the processor 130 of FIG. 1.

In one embodiment, the classification of the second data results in the creation of various data entry categories 405 that include data pertaining to items or functions 406 of the vehicle (for example, vehicle windows, vehicle engine, vehicle drive train, vehicle climate control, vehicle braking, vehicle entertainment, vehicle tires, and so on), various possible failure modes 408 (e.g., window switch is not operating), effects 410 (for example, window is not opening completely, window is stuck, and so on), and causes 412 (for example, window switch is stick, window pane is broken, and so on).

A listing of vehicle symptoms is then collected from the second data (step 414). During step 414, indications of the vehicle symptoms are collected from the second data and are merged to remove duplicate symptom data elements. In one such embodiment, during step 414, if a data entry of the verbatim data for the second data includes a reference to a particular symptom (Sᵢ) that is not a member of any other string, then this symptom reference (Sᵢ) is collected. If such a particular symptom (Sᵢ) is a part of another string, then this symptom (Sᵢ) is not collected if this other string has already been accounted for, to avoid duplication.

As a result of step 414, second data output 416 is generated using the strings. The second data output 416 preferably includes a first component 418 and a second component 420. The first component 418 pertains to a particular part that is identified in the verbatim data for the second data, and may be characterized in the form of {P₁, . . . , Pᵢ}, similar to the discussion above with respect to the first component 330 of the first data output 328. The second component 420 pertains to a particular symptom pertaining to the identified part, and may be characterized in the form of {S₁, . . . , Sᵢ), similar to the discussion above with respect to the second component 332 of the first data output 328. The collection of the symptoms and generation of the output is preferably performed by the processor 130 of FIG. 1.

Returning to FIG. 3, contextual information is collected (step 214). The contextual information preferably pertains to the symptoms identified in the first data output 328 of FIG. 4 and the second data output 416 of FIG. 5. In one embodiment, the contextual information includes information as to vehicles, vehicle systems, parts, failure modes, and causes of the identified symptoms, as well as measures of how often the identified symptoms are typically associated with various different types of vehicles, vehicle systems, parts, failure modes, causes, and so on. The contextual information is preferably collected by the processor 130 of FIG. 1 based on the vehicle data 142 stored in the memory 132 of FIG. 1. The contextual information preferably pertains to the contextual information 162 of FIG. 2.

A syntactic similarly is then calculated between respective data elements for the first data and the second data (step 216). The syntactic similarity (also referred to herein as a “syntactic score”) is preferably calculated using the first data output 328 (including the symptoms or effects collected in sub-process 201 for the first data) and the second data output 416 (including the symptoms or effects collected in sub-process 211). In one embodiment, the contextual information is also utilized in calculating the syntactic similarity. By way of further explanation, in one embodiment the syntactic similarity is between two phrases (e.g., Effects from the DFEMA and the Symptoms from the field warranty data). Also in one embodiment, to calculate the syntactic similarity the information co-occurring with these two phrases from the corpus of the field data is collected. This context information takes the form of Parts, Symptoms, and Actions associated with two phrases, and if the Parts, Symptoms and Actions co-occurring with both the phrases show high degree of overlap, then it indicates that the two phrases are in fact one and the same but written using inconsistence vocabulary. Alternatively, if the contextual information co-occurring with these two phrases show less degree of overlap, it indicates that they are not similar to each other. The syntactic similarity is preferably calculated by the processor 130 of FIG. 1 based on a Jaccard Distance between respective data elements of the first data and the second data, as discussed below. Steps 214 and 216 are also denoted in FIG. 3 as a combined sub-process 218. The syntactic similarity preferably corresponds to the syntactic similarity 164 of FIG. 2.

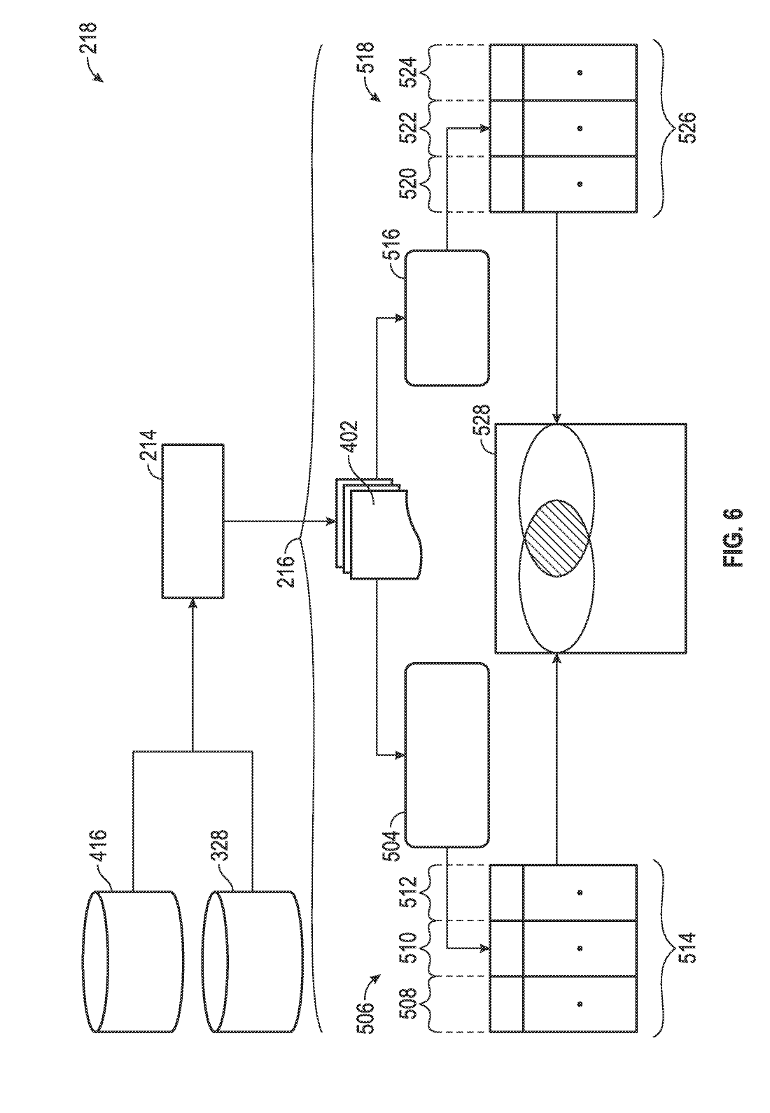

With reference to FIG. 6, a flowchart is provided for the sub-process 218 of FIG. 3, namely, determining the syntactic similarity. As shown in FIG. 6, the first data output 328, the second data output 416, and the contextual information of step 214 are used are used together with the verbatim data of the second data of step 402 of FIG. 5 to determine the syntactic similarity.

In step 504, the verbatim data of the second data of step 402 is filtered with the second data output 416. Step 504 is preferably performed by the processor 130 of FIG. 1, and results in a first matrix 506 of values. As depicted in FIG. 6, the first matrix 506 includes its own vehicle part values (P₁, P₂, . . . Pᵢ) 508, vehicle symptom values (S₁, S₂, . . . Sₘ) 510, and vehicle action values (A₁, A₂, . . . Aₙ) 512, along with a first co-occurring phrase set 514. While filtering out the repair verbatim or any second data, preferably only data points are selected that consists of records of the symptoms which are occurring on their own as an individual phrase without being a member of any longer phrase.

In step 516, the verbatim data of the second data of step 402 is filtered with the first data output 328. Step 516 is preferably performed by the processor 130 of FIG. 1, and results in a second matrix 518 of values. As depicted in FIG. 6, the second matrix 518 includes various vehicle part values (P₁, P₂, . . . P₁) 520, vehicle symptom values (S₁, S₂, . . . Sₘ) 522, and vehicle action values (A₁, A_{z}, . . . Aₙ) 524, along with a second co-occurring phrase set 526.

A Jaccard Distance is calculated between the first and second matrices 506, 518 (step 528). In a preferred embodiment, the Jaccard Distance is calculated by the processor 130 of FIG. 1 in accordance with the following equation:

$$Jaccard Distance = \frac{{S}_{1} ⋂ {S}_{2}}{{S}_{1} ⋃ {S}_{2}} , \qquad ( Equation 1$$

in which S₁ represents the first co-occurring phrase set 514 of the first matrix 506 and S₂ represents the second co-occurring phrase set 526 of the second matrix 518. Typically S₁ consists of phrases, such as parts, symptoms and actions co-occurring with Symptom from the field data whereas S₂ consists of phrases such as parts, symptoms, and action co-occurring with Effect from DFMEA. The phrase co-occurrence is preferably identified by applying a word window of four words on the either side. For example, if a verbatim consists of a particular Symptom, then the various phrases that are recorded for the Symptom in a verbatim are collected. From the collected phrases, symptoms and actions pertaining to this Symptom are collected to construct S₁. The same process is applied to construct S₂ from all such repair verbatim corresponding to a particular Effect. The process is then repeated for each of the Symptoms and Effects in the data. Accordingly, by taking the intersection of the first and second co-occurring phrases 514, 526 and dividing this value by the union of the first and second co-occurring phrases 514, 526, the Jaccard Distance takes into account the overlap of the co-occurring phrases 514, 526 as compared with the overall frequency of such phrases in the data.

Returning to FIG. 3, a determination is made as to whether the syntactic similarity is greater than a predetermined threshold (step 220). The predetermined threshold is preferably retrieved from the look-up table 147 of FIG. 1, preferably also corresponding to the look-up tables 160 of FIG. 2. Similar to the discussion above, the syntactic similarity used in this determination preferably comprises the Jaccard Distance between the first and second co-occurring phrases 514, 526 of FIG. 6, as discussed above in connection with step 528 of FIG. 6. In one embodiment, the predetermined threshold is equal to 0.5; however, this may vary in other embodiments. The determination of step 220 is preferably made by the processor 130 of FIG. 1.

If the syntactic similarity is greater than the predetermined threshold, then the first and second co-occurring phrases are determined to be related, and are preferably determined to be synonymous, with one another (step 222). Conversely, if the syntactic similarity is less than the predetermined threshold, then the first and second co-occurring phrases are not considered to be synonymous, but are used as new information pertaining to the vehicles (step 224). In one embodiment, all such phrases with Jaccard Distance score is less than 0.5 are treated as the ones which are not presently recorded in the DFMEA data, whereas all such phrases with Jaccard Distance score greater than 0.5 are treated as the synonymous of Effect from the DFMEA.

In either case, the results can be used for effectively combining data from various sources (e.g. the first and second data), and can subsequently be used for further development and improvement of the vehicles and products and services pertaining thereto. For example, the information provided via the syntactic similarity can be used to augment or otherwise improve data (such as the data to be augmented 151 of FIG. 2, preferably corresponding to the DFMEA data), for example by grouping synonyms (i.e., terms with a high degree of syntactic similarity with one another) together for analysis, and so on. The determinations of steps 222 and 224 and the implementation thereof are preferably made by the processor 130 of FIG. 1.

For example, in one such embodiment, the process 300 helps to bridge the gap between successive model years for a particular vehicle model. Typically DFMEA data is developed during early stages of vehicle development. Subsequently, large amount of data is collected in the field either from the existing fleet, or whenever new version of the existing vehicle is designed. This may also reveal new Failure Modes, Effects, Causes that can be observed in the field data. Typically, given the size of the data that is collected in the field, it would not generally be possible to manually compare and contrast the new data with the DFMEA data to augment old DFMEA's in-time and periodically. However, the techniques disclosed in this Application (including the process 300 and the corresponding system 100 of FIG. 1 and flow path 150 of FIG. 2) allows for the automatic comparison of the data associated with existing vehicle fleet or the one coming from new release of the existing vehicle, and suggest new Failure Modes, Effects, Causes which are not there in the existing DFMEAs which need to be augmented in them to make the future releases more and more fault free and robust.

Table 1 below shows exemplary syntactic similarity results from step 220 of the process 200 of FIG. 3, in accordance with one exemplary embodiment.

TABLE 1

| | New Information | | Semantic |
|---|---|---|---|
| DFMEA Effect | for Parts | Synonyms | Similarity Value |
| Windows not | INDIVIDUAL | WILL NOT GO | 1 |
| Working | SWITCH | DOWN | |
| | W/L SWITCH, | WOULD NOT | 0.9705 |
| | INDIVIDUAL | WORK | |
| | SWITCH | | |
| | MODULE | OPERATION | 0.5625 |
| | SWITCH | PROBLEM | |
| Bad performance | BUTTON (W/L) | WILL NOT GO | 1 |
| | PLUNGER (Auto), | DOWN | |
| | BUTTON (Auto), | | |
| | BOX (2P), | | |
| | INDIVIDUAL | WOULD NOT | 0.6206896551724138 |
| | SWITCH | WORK | |
| | W/L SWITCH, | | |
| | INDIVIDUAL | INTERNAL FAIL | 0.7 |
| | SWITCH | | |
| | MODULE | | |
| | SWITCH, | | |
| | SWITCH | DAMAGED | 0.9655172413793104 |
| | ASSEMPLY | | |
| | POWER WINDOW | | |
| | (BOX ASSEMBLY) | | |

| | New Information | | Semantic |
|---|---|---|---|
| DFMEA Effect | for Parts | New Information | Similarity Value |
| Windows not | INDIVIDUAL SWITCH | NOT LOCKED IN ALL | 0.2058 |
| Working | | THE WAY | |
| | W/L SWITCH, | WON'T GO ALL THE | 0.21875 |
| | INDIVIDUAL SWITCH | WAY | |
| | MODULE SWITCH | WON'T ROLL UP | 0.44117 |
| | | NOT UNLOCKING | 0.46875 |
| | | IS NOT TURNING | 0.46875 |
| | | ON | |
| Bad | BUTTON (W/L) | INOPERATIVE | 0.3448 |
| performance | PLUNGER (Auto), | | |
| | BUTTON (Auto), | HAS DELAY | 0.42068 |
| | BOX (2P), | | |
| | INDIVIDUAL SWITCH | LOOSE | 0.5172 |
| | W/L SWITCH, | CONNECTION | |
| | INDIVIDUAL SWITCH | NOTE OPERATE | |
| | MODULE SWITCH, | | |
| | SWITCH ASSEMPLY | | |
| | POWER WINDOW | | |
| | (BOX ASSEMBLY) | | |

In the exemplary embodiment of TABLE 1, syntactic similarity is determined in an application using multiple data sources (namely, DFMEA data and field data) pertaining to the functioning of vehicle windows. Also in the embodiment of TABLE 1, the predetermined threshold for the syntactic similarity (i.e., for the Jaccard Distance) is equal to 0.5.

As shown in TABLE 1, the phrase “windows not working” is considered to be synonymous with respect to the terms “will not go down” (with a perfect syntactic similarity score of 1.0), “would not work” (with a near-perfect syntactic score of 0.9705), and “operation problem” (with a syntactic score of 0.5625 that is still above the predetermined threshold), as used for certain window related references. However, the phrase “windows not working” is considered to be not synonymous with respect to the terms “not locked all the way” (with a syntactic similarity score of 0.2058), “won't go all the way” (with a syntactic score of 0.21875), “won't roll up” (with a syntactic score of 0.44117), “not unlocking” (with a syntactic score of 0.46875), and “is not turning on” (also with a syntactic score of 0.46875), as used for certain window related references (namely, because each of these syntactic scores are less than the predetermined threshold in this example).

Also as shown in TABLE 1, the phrase “bad performance” is considered to be synonymous with respect to the terms “will not go down” (with a perfect syntactic similarity score of 1.0), “would not work” (with a near-perfect syntactic score of 0.62069), “internal fail” (with a syntactic score of 0.7 that is above the predetermined threshold), “damaged” (with a syntactic score of 0.96552 that is above the predetermined threshold), and “loose connection” (with a syntactic score of 0.5172, that is still above the exemplary threshold of 0.5), as used for certain window related references. However, the phrase “bad performance” is considered to be not synonymous with respect to the terms “inoperative” (with a syntactic similarity score of 0.3448), “has delay” (with a syntactic score of 0.42068), and “not operate” (with a syntactic score of 0.34615), as used for certain window related references (namely, because each of these syntactic scores are less than the predetermined threshold in this example). In addition, Applicant notes that the terms appearing under the heading “New Information for Parts” in TABLE 1 are terms identified from DFMEA documentation. For example, the terms “windows not working” has a score of 0.2058 with respect to “not locked in all the way”, as well as for “module switch locked in all the way.”

It will be appreciated that the disclosed systems and processes may differ from those depicted in the Figures and/or described above. For example, the system 100, the sources 102, and/or various parts and/or components thereof may differ from those of FIG. 1 and/or described above. Similarly, certain steps of the process 200 may be unnecessary and/or may vary from those depicted in FIGS. 2-6 and described above. In addition, while two types of data (from two data sources) are illustrated in FIGS. 2-6, it will be appreciated that the same techniques can be utilized in combining any number of types of data (from any number of data sources). It will similarly be appreciated that various steps of the process 200 may occur simultaneously or in an order that is otherwise different from that depicted in FIGS. 2-6 and/or described above. It will similarly be appreciated that, while the disclosed methods and systems are described above as being used in connection with automobiles such as sedans, trucks, vans, and sports utility vehicles, the disclosed methods and systems may also be used in connection with any number of different types of vehicles, and in connection with any number of different systems thereof and environments pertaining thereto.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing the exemplary embodiment or exemplary embodiments. It should be understood that various changes can be made in the function and arrangement of elements without departing from the scope of the appended claims and the legal equivalents thereof.

1. A method comprising:
obtaining first data comprising data elements pertaining to a first plurality of vehicles;
obtaining second data comprising data elements pertaining to a second plurality of vehicles; and
combining the first data and the second data, via a processor, based on syntactic similarity between respective data elements of the first data and the second data.

2. The method of claim 1, wherein the first data and the second data are obtained from different sources.

3. The method of claim 1, wherein:
the first data comprises design failure mode and effects analysis (DFMEA) data that is generated using vehicle warranty claims; and
the second data comprises vehicle field data.

4. The method of claim 1, wherein the step of combining the first data and the second data comprises:
calculating, via the processor, a measure of syntactic similarity pertaining to respective data elements of the first data and the second data; and
determining, via the processor, that the respective data elements of the first data and the second data are related to one another based on the calculated measure of the syntactic similarity.

5. The method of claim 4, wherein the step of calculating the measure of the syntactic similarity comprises calculating, via the processor, the measure of syntactic similarity between terms associated with vehicle symptoms derived from the respective data elements of the first data and the second data.

6. The method of claim 4, wherein:
the step of calculating the measure of the syntactic similarity comprises calculating, via the processor, a Jaccard Distance between terms derived from the respective data elements of the first data and the second data; and
the step of determining that the respective data elements are related comprises determining, via the processor, that the respective data elements of the first data and the second data are related if the Jaccard Distance exceeds a predetermined threshold.

7. The method of claim 6, wherein the step of determining that the respective data elements are related comprises:
determining, via the processor, that the respective data elements of the first data and the second data are synonymous if the Jaccard Distance exceeds the predetermined threshold.

8. The method of claim 6, wherein:
the respective data elements of the first data and the second data comprise strings representing vehicle parts, vehicle systems, and vehicle actions; and
the step of calculating the Jaccard Distance comprises calculating, via the processor, the Jaccard Distance between the respective strings of the respective data elements of the first data and the second data.

9. A program product comprising:
a program configured to at least facilitate:
obtaining first data comprising data elements pertaining to a first plurality of vehicles;
obtaining second data comprising data elements pertaining to a second plurality of vehicles; and
combining the first data and the second data based on syntactic similarity between respective data elements of the first data and the second data; and
a non-transitory, computer readable storage medium storing the program.

10. The program product of claim 9, wherein
the first data comprises design failure mode and effects analysis (DFMEA) data that is generated using vehicle warranty claims; and
the second data comprises vehicle field data.

11. The program product of claim 9, wherein the program is further configured to at least facilitate:
calculating a measure of syntactic similarity between respective data elements of the first data and the second data; and
determining that the respective data elements of the first data and the second data are related to one another based on the calculated measure of the syntactic similarity.

12. The program product of claim 11, wherein the program is further configured to at least facilitate:
calculating a Jaccard Distance between respective data elements of the first data and the second data; and
determining that the respective data elements of the first data and the second data are related if the Jaccard Distance exceeds a predetermined threshold.

13. The program product of claim 12, wherein the program is further configured to at least facilitate determining that the respective data elements of the first data and the second data are synonymous if the Jaccard Distance exceeds the predetermined threshold.

14. The program product of claim 12 wherein:
the respective data elements of the first data and the second data comprise strings representing vehicle parts, vehicle systems, and vehicle actions; and
the program is further configured to at least facilitate calculating the Jaccard Distance between the respective strings of the respective data elements of the first data and the second data.

15. A system comprising:
a memory storing:
first data comprising data elements pertaining to a first plurality of vehicles;
second data comprising data elements pertaining to a second plurality of vehicles; and
a processor coupled to the memory and configured to combine the first data and the second data based on syntactic similarity between respective data elements of the first data and the second data.

16. The system of claim 15, wherein
the first data comprises design failure mode and effects analysis (DFMEA) data that is generated using vehicle warranty claims; and
the second data comprises vehicle field data.

17. The system of claim 15, wherein the processor is further configured to:
calculate a measure of syntactic similarity between respective data elements of the first data and the second data; and
determine that the respective data elements of the first data and the second data are related to one another based on the calculated measure of the syntactic similarity.

18. The system of claim 17, wherein the processor is further configured to:
calculate a Jaccard Distance between respective data elements of the first data and the second data; and
determine that the respective data elements of the first data and the second data are related if the Jaccard Distance exceeds a predetermined threshold.

19. The system of claim 18, wherein the processor is further configured to determine that the respective data elements of the first data and the second data are synonymous if the Jaccard Distance exceeds the predetermined threshold.

20. The system of claim 18, wherein:
the respective data elements of the first data and the second data comprise strings representing vehicle parts, vehicle systems, and vehicle actions; and
the processor is further configured to calculate the Jaccard Distance between the respective strings of the respective data elements of the first data and the second data.
